(19) United States
(12) Patent Application Publication
(10) Pub. No.: US 2016/0301270 A1
(43) Pub. Date: Oct. 13, 2016

(54) Motor Core and Motor

(71) Applicant: NSK LTD., Shinagawa-ku, Tokyo (JP)

(72) Inventors: Yusuke OTA, Kanagawa (JP); Hayao WATANABE, Kanagawa (JP); Shigeru ENDOU, Kanagawa (JP)

(21) Appl. No.: 15/100,382

(22) PCT Filed: Jan. 5, 2015
(86) PCT No.: PCT/JP2015/000010

§ 371 Date: May 31, 2016

(30) Foreign Application Priority Data
Jan. 6, 2014 (JP) 2014-000442

(51) Int. Cl. H02K 1/27; H02K 21/16; H02K 1/14

(52) U.S. Cl. CPC H02K 1/278; H02K 1/146; H02K 21/16; H02K 1/276

(57) ABSTRACT

To provide a motor core and a motor capable of reducing cogging torque and torque ripple by the shape of a pole tooth of a stator. An end surface of a pole tooth of a stator is formed such that a cross-section of the end surface along a circumferential direction is a curved surface having an arc shape that protrudes in a direction opposite to a direction in which an end surface of a magnet of a rotor (equivalent to an outer periphery of a rotor yoke part), which is opposed to the end surface, protrudes.

### TECHNICAL FIELD

The present invention relates to a motor core and a motor.

### BACKGROUND ART

Conventionally, as technologies for reducing cogging torque and torque ripple generated when driving a motor, there are technologies described in PTL 1 to 3, for example.

PTL 1 describes a magnet type motor including a cylindrical stator, a cylindrical rotor that is provided coaxially with the stator and rotatably, and a permanent magnet that is provided on the outer periphery of the rotor and has a shape in which a central part of an opposed surface to the stator in a circumferential direction is an arc surface and chamfered surfaces are provided on both end parts of the opposed surface in the circumferential direction.

In addition, PTL 2 describes a stator core including an annular yoke part, and integrally-formed teeth protruding on the inner periphery of the yoke part at regular intervals, in which a space formed between the adjacent two teeth has a skew structure.

In addition, PTL 3 describes a motor including a rotor that has a plurality of segment magnets on the outer peripheral part and rotates around a rotation axis, and a stator having an armature block that is arranged on the side of the outer periphery of the rotor and includes an arc-shaped core back part and a teeth part extending from the core back part in an axial direction. In the motor, the outer periphery of the segment magnet is formed to have a curved shape such that an air gap between the outer periphery and a surface of the teeth part, which is opposed to the segment magnet, becomes larger toward both end parts from a central part.

### CITATION LIST

### Patent Literature

PTL 1: JP 2004-328818 A

PTL 2: JP 2008-029157 A

PTL 3: JP 2008-104305 A

### SUMMARY OF INVENTION

### Technical Problem

However, in the conventional technology of PTL 1 described above, the opposed surface of the permanent magnet has a shape combining the arc surface and the chamfered surfaces, the magnet shape becomes complex, and thus, the processing cost of the magnet may be increased. In addition, since the chamfered surfaces are provided on both end parts of the opposed surface, the thickness of the permanent magnet at both end parts is smaller compared to that at the central part, and a permeance coefficient is reduced. Thus, demagnetization may become prone to occur due to a demagnetizing field generated from a coil provided on the stator.

In addition, in the conventional technology of PTL 2 described above, the space between the adjacent teeth has the skew structure, and thus, it becomes difficult to increase the occupancy rate of winding. Thus, it may become difficult to increase torque of a motor.

In addition, in the conventional technology of PTL 3 described above, the outer periphery of the segment magnet is formed to have the curved shape such that the air gap with the opposed surface of the teeth part becomes larger toward both end parts from the central part, and thus, the thickness of the segment magnet becomes thinner toward both end parts from the central part. Thus, a permeance coefficient is reduced and demagnetization may become prone to occur due to a demagnetizing field generated from a coil provided on the stator.

The present invention has been made by focusing on unresolved problems of the foregoing conventional technologies, and an object of the present invention is to provide a motor core and a motor suitable for reducing cogging torque and torque ripple at low cost without making a stator have a skew structure, partially thinning the thickness of a magnet, or the like.

### Solution to Problem

In order to achieve the object mentioned above, according to a first aspect of the present invention, there is provided a motor core in which each of end surfaces of plural pole teeth provided on an inner periphery of a stator along a circumferential direction of the inner periphery is formed such that a cross-section of the end surface along the circumferential direction is a curved surface having an arc shape that protrudes in a direction opposite to a direction in which an outer periphery of an annular rotor opposed to the end surface protrudes, the annular rotor having a plurality of magnetic poles opposed to end surfaces of the pole teeth across an air gap, and arranged concentrically with the stator inside the stator and along the circumferential direction.

According to a second aspect of the present invention, there is provided a motor comprising the motor core according to the first aspect.

### Advantageous Effects of Invention

According to the present invention, each of the end surfaces of the pole teeth of the stator is formed such that a cross-sectional shape of the end surface along the circumferential direction is a curved surface having an arc shape that protrudes in a direction opposite to a direction in which the outer periphery of the rotor protrudes, and thus, the shape of magnetic flux can be brought closer to a sinusoidal shape (ideal waveform), compared to a configuration without such an arc shape. Accordingly, an effect capable of reducing cogging torque and torque ripple generated when the motor core is applied to a motor is obtained without processing of partially thinning a magnet of a rotor, making a stator have a skew structure, or the like.

### BRIEF DESCRIPTION OF DRAWINGS

FIG. 1 is a plan view illustrating a structure of a motor core 1 of a first embodiment;

FIG. 2 is a partial plan view illustrating a configuration in which an exciting coil 15 is wound around pole teeth 12 of the motor core 1 of FIG. 1;

FIG. 3 is a partially-enlarged plan view including the pole tooth 12 and a magnet 22 of the motor core 1 of FIG. 1;

FIG. 4 is an axial sectional view illustrating a structure of a motor of a second embodiment;

FIG. 5 is a plan view illustrating a structure of an interior-magnet rotor 20 of a modified example; and

FIG. 6 is a partially-enlarged plan view including the pole tooth 12 and the magnet 22 when the interior-magnet rotor 20 of the modified example is applied to the motor core 1 of the first embodiment.

### DESCRIPTION OF EMBODIMENTS

### First Embodiment

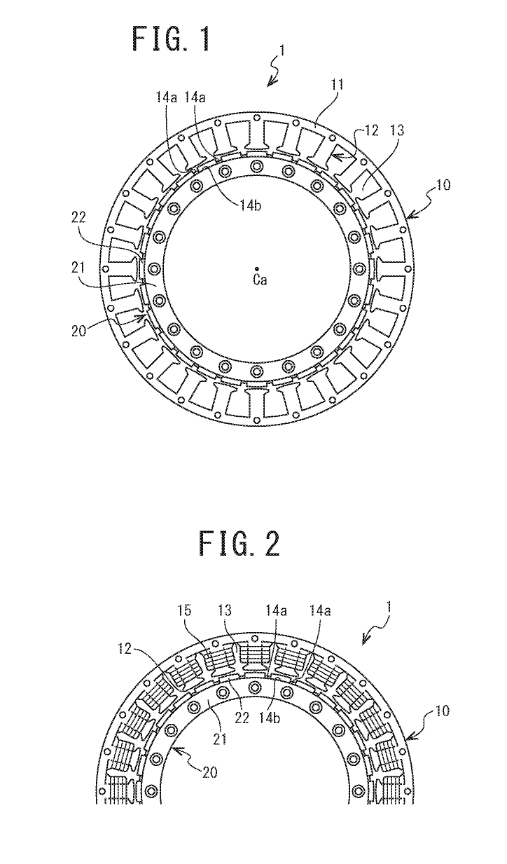

As illustrated in FIG. 1, a motor core 1 according to a first embodiment is an inner rotor type in which an annular rotor 20 is combined with the inside of an annular stator 10.

The stator 10 includes an annular stator yoke part 11, and a plurality of pole teeth 12 provided on the inner periphery of the stator yoke part 11 to protrude inwardly in a radial direction and provided at regular intervals in a circumferential direction. Gaps formed between the respective adjacent pole teeth 12 configure slots 13.

As illustrated in FIG. 2, the stator 10 is configured such that an exciting coil 15 is wound around the respective pole teeth 12 through the slots 13. In the example illustrated in FIG. 2, concentrated winding is adopted as a winding method of the exciting coil 15. It is to be noted that another winding method, such as distributed winding, can also be adopted without limiting to the concentrated winding.

In addition, the stator 10 is configured by an integrated (single) core configuration with a magnetic steel sheet. It is to be noted that, for example, the stator 10 maybe composed of another material, such as a dust core, without limiting to the magnetic steel sheet or may be configured by another configuration, such as a divided (laminated) core configuration, without limiting to the integrated core configuration.

In addition, the stator 10 is a stator to be fixedly-supported by a motor housing or the like when configuring a motor.

On the other hand, as illustrated in FIG. 1, the rotor 20 includes an annular rotor yoke part 21, and a plurality of magnets 22 opposed to the pole teeth 12 with an air gap interposed therebetween and provided on the outer periphery of the rotor yoke part 21 at regular intervals in the circumferential direction. More specifically, the rotor 20 of the first embodiment is configured as a surface magnet type rotor.

Specifically, protrusions 14a that protrude outwardly in the radial direction so as to position the magnets 22 in an axial direction are provided on the outer periphery of the rotor yoke part 21. For example, the magnets 22 are positioned by the protrusions 14a and fixed to magnet pasting surfaces 14b on the outer periphery of the rotor yoke part 21 with an adhesive agent.

In addition, the magnets 22 are arranged such that the lines of magnetic force are directed in the radial direction and the magnetic pole direction reverses every other magnet. More specifically, the S-pole and N-pole magnets 22 are alternately arranged in the circumferential direction.

In addition, the rotor yoke part 21 is composed of iron. It is to be noted that, for example, the rotor yoke part 21 may be composed of another material, such as a magnetic steel sheet or a dust core, without limiting to iron.

In addition, the magnets 22 are composed of neodymium magnets. It is to be noted that, for example, the magnets 22 may be composed of other magnets, such as ferrite magnets, bonded neodymium magnets, or samarium-cobalt magnets, without limiting to the neodymium magnets.

In addition, as illustrated in FIG. 1, both a surface on the outer diameter side and a surface on the inner diameter side of the magnet 22 with respect to the rotor yoke part 21 are formed such that cross-sections thereof along the circumferential direction (hereinafter, referred to as “circumferential direction cross-sections”) are curved surfaces having an arc shape that is the same as the outer periphery of the rotor yoke part 21 has. More specifically, the magnet 22 has an arcuate shape when planarly-viewed in the axial direction.

In addition, the rotor 20 is a rotor to be arranged concentrically with the stator 10 (center Ca in FIG. 1) and rotatably-supported relative to the stator 10 when configuring a motor.

In addition, as illustrated in FIG. 1, in order for the total number S of the slots 13 (hereinafter, referred to as “the number of slots S”) to be “24” and in order for the number P of poles of the rotor 20 (the total number of the magnets 22) to be “28”, the motor core 1 configures the number of slots and the number of poles. Therefore, when the number of exciting phases N is 3, the number of slots q per pole per phase is “q=S/(N·P)=24/84=2/7”. More specifically, the motor core 1 of the first embodiment has a fractional-slot configuration.

More specifically, the fractional-slot configuration is a configuration in which the number of slots q per pole per phase is a fraction. The number of slots q per pole per phase is a value obtained by dividing the number of slots (the number of grooves for winding coil winding) S of the stator by the number of phases N and the number of poles P.

It is to be noted that the number of slots S and the number of poles P may be any combination as long as the motor core 1 is the fractional-slot configuration, without limiting to the combination of “S=24” and “P=28”. In addition, the number of phases N may be another number of phases, such as two or five phases, without limiting to the three phases.

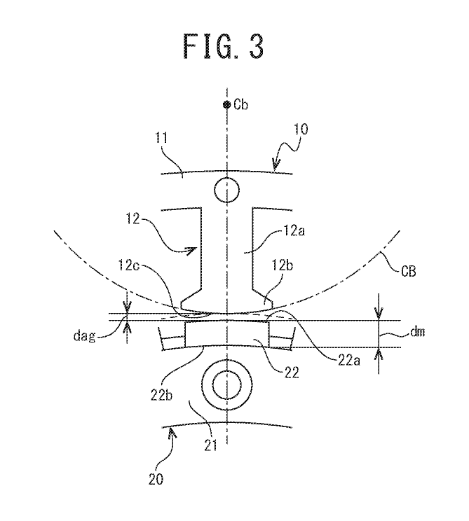

Next, a detailed configuration of the pole tooth 12 of the stator 10 will be described on the basis of FIG. 3.

As illustrated in FIG. 3, the pole tooth 12 includes a tooth body 12a integrally-formed on the stator yoke part 11 to protrude inwardly in the radial direction, and a flanged end part 12b formed at the end of the tooth body 12a. In addition, the stator 10 and the rotor 20 are configured such that an end surface 12c of the end part 12b and an end surface 22a of the magnet 22 are opposed to each other with an air gap dag having a preset dimension interposed therebetween.

The end part 12b is formed to be a flange shape, so that the width of the end part 12b in the circumferential direction is larger than the width of the magnet 22. The magnetic flux of the magnet can be effectively used by the configuration.

The end surface 22a of the magnet 22 (hereinafter, referred to as “magnet end surface 22a”) is formed such that a cross-section thereof along the circumferential direction is a curved surface having an arc shape along the circumferential direction cross-section of the outer periphery of the rotor yoke part 21. In contrast, in the first embodiment, the end surface 12c of the pole tooth 12 (hereinafter, referred to as “pole tooth end surface 12c”) is formed such that a circumferential direction cross-section thereof is a curved surface having an arc shape that protrudes in a direction opposite to a direction in which the circumferential direction cross-section of the magnet end surface 22a (i.e. the outer periphery of the rotor yoke part 21) protrudes.

In addition, in the first embodiment, the curvature R of the arc of the pole tooth end surface 12c is, as illustrated in FIG. 3, curvature of an arc along a circle CB centered at a center point Cb set outside the outer periphery of the stator yoke part 11.

The air gap dag between the pole tooth end surface 12c and the magnet end surface 22a becomes larger as the curvature R becomes larger, and torque is reduced as the air gap dag becomes larger.

Therefore, the position of the center point Cb is determined in consideration of a balance between the amount of a reduction in torque due to the dimension of the air gap dag with the magnet 22 and the amount of a reduction in cogging torque and torque ripple due to the curvature R of the arc of the pole tooth end surface 12c. More specifically, it is preferable that the position of the center point Cb (i.e. curvature R) be set at a position where the amount of a reduction in cogging torque and torque ripple becomes maximum within an acceptable range of the amount of a reduction in torque (for example, within a range set in accordance with the intended use of the motor), for example.

In addition, it is assumed that the motor core 1 of the first embodiment is applied to, for example, a motor in which the dimension of the air gap dag needs to be made relatively large, such as a canned motor. In this case, when the air gap dag becomes larger, the thickness dm of the magnet 22 needs to be increased so as to increase torque.

However, when the thickness dm of the magnet 22 is increased, the cost of the magnet 22 is increased. Thus, for example, the dimensions of the respective components, such as the thickness dm of the magnet 22 and the curvature R of the arc of the pole tooth end surface 12c, are set such that the dimension of the air gap dag is about ⅓ of the thickness dm of the magnet 22. In this manner, it is preferable that a balance between the performance and the cost be kept in consideration of the thickness of the magnet 22.

In addition, in the first embodiment, a pasting surface 22b of the magnet 22 on the inner diameter side is also formed such that a circumferential direction cross-section thereof is a curved surface having an arc shape along the circumferential direction cross-section of the outer periphery of the rotor yoke part 21 (magnet pasting surface 14b) as is the case with the magnet end surface 22a. More specifically, the magnet 22 is formed to be an arcuate shape such that the thickness dm thereof in the radial direction is a uniform thickness.

In the first embodiment, the stator 10 corresponds to a stator, the rotor 20 corresponds to a rotor, the pole teeth 12 correspond to pole teeth, the pole tooth end surfaces 12c correspond to end surfaces of the pole teeth, and the magnet end surfaces 22a correspond to opposed surfaces of magnets.

### Effects of First Embodiment

(1) The motor core 1 includes the annular stator 10 having the plurality of pole teeth 12 provided on the inner periphery along the circumferential direction thereof, in which the slots 13 are formed between the respective pole teeth 12, and the annular rotor 20 having the plurality of magnetic poles (magnets 22) opposed to pole tooth end surfaces 12c across the air gap, and arranged concentrically with the stator 10 inside the stator 10 and along the circumferential direction. Each of the pole tooth end surfaces 12c is formed such that a cross-section of the pole tooth end surface 12c along the circumferential direction is a curved surface having an arc shape that protrudes in a direction opposite to a direction in which the outer periphery of the rotor 20, which is opposed to the pole tooth end surface 12c, protrudes.

More specifically, the pole tooth end surface 12cis formed such that the circumferential direction cross-section thereof is a curved surface having an arc shape that protrudes in a direction opposite to a direction in which the circumferential direction cross-section of the magnet end surface 22a (the outer periphery of the rotor yoke part 21) protrudes. Accordingly, the shape of the magnetic flux generated when the motor core 1 is applied to a motor can be brought close to the sinusoidal shape, and thus, cogging torque and torque ripple can be reduced.

(2) In the motor core 1, the rotor 20 is a surface magnet type rotor having the magnets 22 that form the plurality of magnetic poles, which are opposed to the pole tooth end surfaces 12c across the air gap and arranged to protrude on the outer periphery in the circumferential direction thereof, and each of magnet end surfaces 22a opposed to the pole tooth end surfaces 12c is formed such that a cross-section of the magnet end surface 22a along the circumferential direction is a curved surface having an arc shape that is the same as the outer periphery of the rotor 20 has.

More specifically, the cross-section of the pole tooth end surface 12c in the circumferential direction has an arc shape that protrudes in a direction opposite to a direction in which the magnet end surface 22a protrudes, and the shape of the magnetic flux can be brought closer to the sinusoidal shape, compared to a configuration without such an arc shape.

Accordingly, in a motor core including a surface magnet type rotor, an effect capable of reducing cogging torque and torque ripple generated when the motor core is applied to a motor is obtained without processing of partially thinning a magnet of a rotor, making a stator have a skew structure, or the like.

In addition, the configuration in which cogging torque and torque ripple are reduced by the shape of the pole tooth end surface 12c is obtained, and thus, the thickness dm of the magnet 22 can be a uniform thickness. Accordingly, it becomes more possible to prevent a reduction in a permeance coefficient due to the thickness of a magnet, compared to a conventional configuration in which the thickness of a magnet is partially thinned. More specifically, an effect capable of more reducing demagnetization which is caused by a demagnetizing field generated from the exciting coil 15 due to the reduction in a permeance coefficient ever than before is obtained.

(3) In the motor core 1, each of the pole tooth end surfaces 12c is formed such that the cross-section of the end surface 12c along the circumferential direction is a curved surface having an arc shape along the circle CB having the center (Cb) outside the outer periphery of the stator 10.

More specifically, the curvature R of the arc of the pole tooth end surface 12c is curvature of an arc along the circle CB centered at the center point Cb set outside the outer periphery of the stator yoke part 11. Accordingly, it becomes more possible to set the curvature R such that the dimension of the air gap dag is an appropriate dimension without being made too large, compared to the case where the center point Cb is set on the inside of the outer periphery. As a result, an effect capable of reducing cogging torque and torque ripple generated when the motor core is applied to a motor is obtained while minimizing a reduction in torque due to enlargement of the air gap between the pole tooth end surface 12c and the magnet end surface 22a.

(4) In the motor core 1, a slot combination between the stator 10 and the rotor 20 is a fractional-slot configuration.

A better induction electric power waveform can be obtained by the configuration, compared to the case where the configuration of the motor core 1 is an integral-slot configuration. Accordingly, cogging torque and torque ripple can be reduced, and thus, an effect of making it easy to increase torque is obtained. In particular, cogging torque prominently generated at low speed can be reduced, and thus, the motor core 1 can be made to have a configuration that is suitably applied to a direct drive motor that requires high torque at low speed, for example.

It is to be noted that the integral-slot configuration is a configuration in which the number of slots q per pole per phase is an integer.

(5) The motor core 1 is made to have a configuration in which the stator 10 is manufactured by being pressed with a mold.

Accordingly, an increase in processing cost of a magnet can be more suppressed, compared to a conventional configuration in which a magnet shape is contrived, and thus, the motor core 1 can be manufactured at relatively low cost.

### Second Embodiment

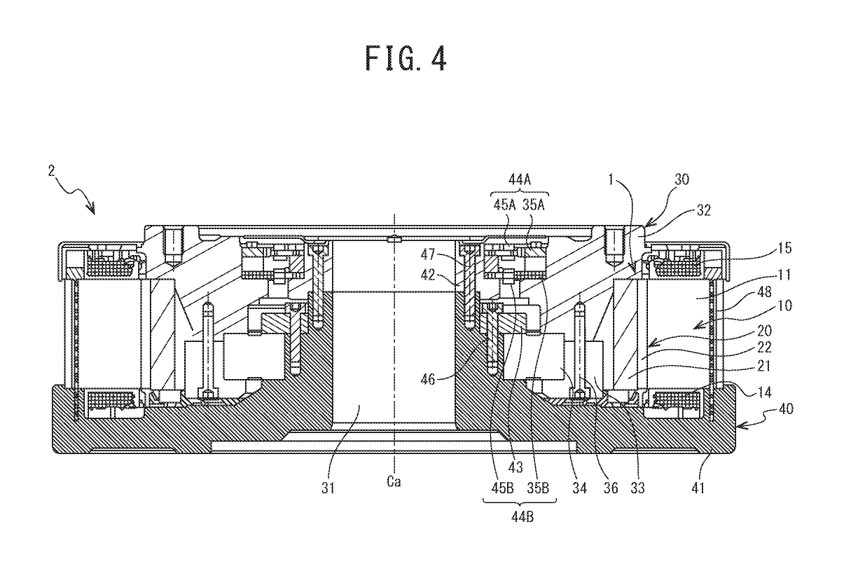

As illustrated in FIG. 4, a motor 2 according to a second embodiment is an inner rotor type motor including the motor core 1 of the above first embodiment.

In addition, the motor 2 is a direct drive motor in which a rotation axis of the motor 2 is directly connected to a load body without interposing a transfer mechanism, such as a gear, a belt, and a roller, to rotate the load body.

As illustrated in FIG. 4, the motor 2 is configured to include a base member 40 that fixes the stator 10 and is attached to a supporting member (not illustrated), a motor rotation axis 30 that is fixed to the rotor 20 and is rotatable with the rotor 20, and a bearing 34 that is interposed between the base member 40 and the motor rotation axis 30 and rotatably supports the motor rotation axis 30 with respect to the base member 40.

The base member 40 includes a substantially disc-shaped housing base 41 and a housing inner 42 that has a hollow part 31 penetrating therein and convexly protrudes from the housing base 41 to surround the hollow part 31. The housing inner 42 is fastened and fixed to the housing base 41 with a fixing member 47, such as a bolt. In addition, the base member 40 is configured to include a housing flange 43 that fixes an inner ring of the bearing 34 to the housing base 41 with a fixing member 46, such as a bolt.

The stator 10 is fastened to the outer peripheral edge of the housing base 41 with a fixing member 48, such as a bolt. Accordingly, the stator 10 is positioned and fixed with respect to the housing base 41. At this time, a central axis of the stator 10 corresponds to the rotation center Ca of the rotor 20.

The exciting coil 15 is wound around the respective pole teeth 12 of the stator 10 through the slots 13 by concentrated winding.

In addition, a wiring (not illustrated) for supplying power from a power source is connected to the stator 10, and the power is supplied to the exciting coil 15 through the wiring.

The motor rotation axis 30 is configured to include an annular rotation axis 32 and a rotor flange 33 that fixes an outer ring of the bearing 34 to the rotation axis 32 with a fixing member 36, such as a bolt.

In the second embodiment, the rotor 20 is integrally fixed to the annular rotation axis 32. It is to be noted that the rotor 20 may be fixed to the rotation axis 32 with a fixing member. The rotation axis 32 is formed such that the annular central axis is concentrically with the rotation center Ca of the motor 2.

In the bearing 34, the outer ring is fixed to the rotor flange 33, and the inner ring is fixed to the housing flange 43. Accordingly, the bearing 34 can rotatably-support the rotation axis 32 and the rotor 20 with respect to the housing base 41. Therefore, the motor 2 can rotate the rotation axis 32 and the rotor 20 with respect to the housing base 41 and the stator 10.

It is to be noted that, as the bearing 34, a cross roller bearing, a ball bearing, a roller bearing, and the like can be adopted.

In addition, the motor 2 includes rotation detectors 44A and 44B. The rotation detectors 44A and 44B are configured by, for example, resolvers, and can detect rotational positions of the rotor 20 and the motor rotation axis 30 with a high degree of accuracy.

The rotation detectors 44A and 44B include fixedly-supported resolver stators 45A and 45B and resolver rotors 35A and 35B that are rotatable with respect to the resolver stators 45A and 45B, and are arranged on the upper side of the bearing 34. In the motor 2 of the second embodiment, the resolver stators 45A and 45B are fixed to the housing inner 42.

Inclusion of cogging torque and torque ripple in rotation of the rotor 20 may cause vibration of the rotation axis 32. The vibration of the rotation axis 32 is transferred to the load body, and accordingly, when a moment is applied such that the center of gravity of the load body is moved, a problem such as shortening of the life of the bearing 34 may occur.

The motor 2 of the second embodiment is configured using the motor core 1 of the above first embodiment. Thus, by the curved surface of the cross-section of the pole tooth end surface 12c in the circumferential direction, which has an arc shape that protrudes in a direction opposite to a direction in which the magnet end surface 22a protrudes, the shape of the magnetic flux can be brought close to the sinusoidal shape. Accordingly, the cogging torque and the torque ripple included in the rotation of the rotor 20 can be reduced. As a result, the vibration of the rotation axis 32 can be suppressed, and a load applied to the bearing 34 or the like can be reduced.

In the second embodiment, the motor 2 corresponds to a motor, the stator 10 corresponds to a stator, the rotor 20 corresponds to a rotor, the pole teeth 12 correspond to pole teeth, the pole tooth end surfaces 12c correspond to end surfaces of the pole teeth, and the magnet end surfaces 22a correspond to opposed surfaces of magnets.

### Effects of Second Embodiment

(1) The motor 2 includes the motor core 1 of the above first embodiment.

The same operation and effects as those of the motor core 1 of the above first embodiment can be obtained by the foregoing configuration.

### Modified Examples

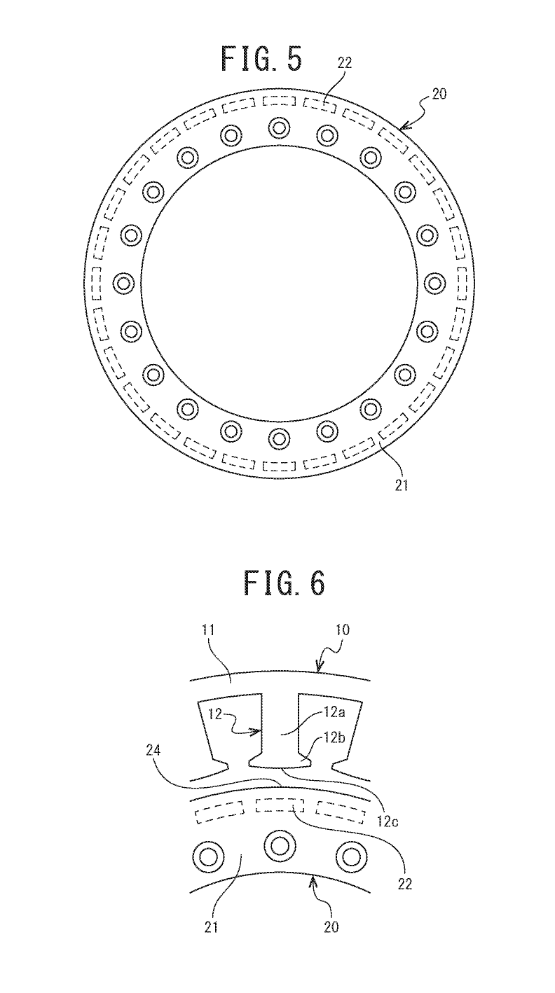

(1) In the above respective embodiments, the configuration of the rotor 20 of the motor core 1 is a surface magnet type rotor configuration, but is not limited to the configuration. For example, as illustrated in FIG. 5, the rotor 20 may be an interior-magnet configuration in which the magnets 22 are arranged and embedded in the rotor yoke part 21 in the circumferential direction. In the case of the configuration, as illustrated in FIG. 6, the pole tooth end surface 12c is formed such that a circumferential direction cross-section thereof is a curved surface having an arc shape that protrudes in a direction opposite to a direction in which a circumferential direction cross-section of an outer periphery 24 of the rotor 20, which is opposed to the pole tooth end surface 12c, protrudes.

(2) In the above respective embodiments, the arc shape of the circumferential direction cross-section of the pole tooth end surface 12c has a shape along the arc of the perfect circle CB having the center Cb, but is not limited to the configuration. The arc shape may be a shape along an arc of an ellipse or the like without limiting to the perfect circle, as long as the shape of the magnetic flux can be brought close to the sinusoidal shape.

In addition, the above respective embodiments are preferred specific examples of the present invention, and various technically-preferable limitations are added thereto. However, the scope of the present invention is not limited to these embodiments unless there is a particular description that limits the present invention in the above description. In addition, for the sake of convenience of illustration, the drawings used in the above description are schematic diagrams in which horizontal and vertical scales of members or parts are different from actual ones.

The entire contents of Japanese Patent Application No. 2014-442 (filed on Jan. 6, 2014) to which the present application claims priority are incorporated herein by reference.

Although the present invention has been described with reference to the limited number of embodiments, the scope of the present invention is not limited thereto, and modifications of the respective embodiments based on the above disclosure are obvious to those skilled in the art.

### REFERENCE SIGNS LIST

1 motor core
2 motor
10 stator
11 stator yoke part
12 pole tooth
12a tooth body
12b end part
12c pole tooth end surface
13 slot
14a protrusion
14b magnet pasting surface
20 rotor
21 rotor yoke part
22 magnet
22a magnet end surface
22b magnet pasting surface
24 outer periphery
30 motor rotation axis
34 bearing
40 base member

1. A motor core comprising:
an annular stator having a plurality of pole teeth provided on an inner periphery of the annular stator along a circumferential direction of the inner periphery, in which slots are formed between the respective pole teeth; and
an annular rotor having a plurality of magnetic poles opposed to end surfaces of the pole teeth across an air gap, and arranged concentrically with the stator inside the stator and along the circumferential direction, wherein
each of the end surfaces of the pole teeth is formed such that a cross-section of the end surface along the circumferential direction is a curved surface having an arc shape that protrudes in a direction opposite to a direction in which an outer periphery of the rotor opposed to the end surface protrudes.

2. The motor core according to claim 1, wherein
the rotor is a surface magnet type rotor having magnets that form the plurality of magnetic poles, which are opposed to the end surfaces of the pole teeth across the air gap and arranged to protrude on the outer periphery in the circumferential direction of the outer periphery, and
opposed surfaces of the magnets, which are opposed to the end surfaces of the pole teeth, are formed such that a cross-section of each of the opposed surfaces along the circumferential direction is a curved surface having an arc shape that is the same as the outer periphery of the rotor has.

3. The motor core according to claim 1, wherein
the end surfaces of the pole teeth are formed such that the cross-section of each of the end surfaces along the circumferential direction is a curved surface having an arc shape along a circle having a center outside an outer periphery of the stator.

4. The motor core according to claim 1, wherein p1 a slot combination between the stator and the rotor is a fractional-slot configuration.

5. A motor comprising the motor core according to claim 1.
